(19) United States
(12) Patent Application Publication
(10) Pub. No.: US 2004/0150906 A1
(43) Pub. Date: Aug. 5, 2004

(54) Servo writing method, servo writer, and program thereof

(76) Inventors: Hiroyuki Yoshimura, Tokyo (JP); Kiminori Sato, Nagano (JP)

Correspondence Address: ROSSI & ASSOCIATES, P.O. Box 826, Ashburn, VA, 20146-0826, US

(21) Appl. No.: 10/659,052

(22) Filed: Sep. 9, 2003

(30) Foreign Application Priority Data
Feb. 5, 2003 (JP) JP2003-028745

(51) Int. Cl. G11B 21/02

(52) U.S. Cl. 360/75

(57) ABSTRACT

A servo writer applies magnetic reproduction signals having a uniform amplitude even with a plurality of magnetic recording heads. The servo writer has an exciting current controller for applying an exciting current to each magnetic recording head to record a magnetic pattern on a magnetic disc, a magnetic reproducing head for reading a magnetic reproduction signal based on the magnetic pattern, a peak detector for holding a peak value read from the magnetic reproduction head, and a CPU for controlling the application of the magnetic pattern so that all the exciting currents are uniformly applied to the magnetic recording heads. The CPU calculates and stores the correction value corresponding to each magnetic recording head based on the peak values detected by the peak detector, and supplies the correction value to the exciting current controller.

### BACKGROUND

Enhancing the positioning precision of a magnetic head can increase storage capacity of a magnetic disc device. Various tracking servo systems have been known to enhance the positioning or tracking precision of a magnetic head. A device for recording a servo signal for positioning a magnetic head, i.e., a servo pattern on a magnetic disc, is referred to as a servo writer.

FIG. 1 shows the construction of a conventional servo writer. The servo writer is equipped with a disc stack unit 13 with magnetic discs 11 for recording servo signals thereon, a clock pattern disc 12, and a spindle motor 14 for rotating the disc stack unit 13 at several thousands rpm. The servo writer is further equipped with a clock head 15 for writing a clock pattern on the clock pattern disc 12, a clock head positioner 16 for positioning the clock head 15, magnetic recording heads 17 for writing servo patterns on the magnetic discs, and a rotary positioner 18 for positioning the magnetic recording heads stacked. Furthermore, the servo writer is equipped with a clock pattern generator 21 for generating a clock pattern, a servo pattern generator 22 for generating a servo pattern, a position detector 23 connected to a rotary encoder 19 for detecting the position of the rotary positioner 18, a servo compensator 24 for calculating a servo compensation value on the basis of an error between the detected position and a target position, and a power amplifier 25 for outputting a driving current for the rotary positioner 18 on the basis of the servo compensation value.

The operation of the servo writer is as follows. As shown in FIG. 2A, the clock head 15 writes a clock pattern generated in the clock pattern generator 21 at any radial position of the clock pattern disc 12. For example, the clock pattern 31 is written on the outermost periphery of the clock pattern disc 12 as shown in FIG. 2B. Next, the position of the rotary positioner 18 is detected by the rotary encoder 19 and the position detector 23, and the error from the target position is fed back through the servo compensator 24 and the power amplifier 25, and each magnetic recording head 17 is made to follow the target position as shown in FIG. 2A. Each magnetic recording head 17 writes the servo pattern generated in the servo pattern generator 22 on each magnetic disc 11 in synchronism with clocks read from the clock pattern disc 12 under the followed state.

In the conventional servo writer, the time required for one disc stack unit to write the servo pattern on the whole surface of each magnetic disc is equal to the disc rotation time times the number of tracks to be written. As the track density is enhanced in connection with increase in storage capacity, the writing time is longer and the throughput is lowered. The time can be shortened by increasing the rotational speed of the magnetic disc. However, the mechanical vibration is intensified as tradeoff, and it is difficult to write the servo pattern with high precision. If the stack number of magnetic discs is increased, the throughput per disc is increased, but the load imposed on a spindle motor is increased, so that the rotation precision is lowered. Furthermore, the number of stacked magnetic recording heads is increased, so that it is difficult to keep the installation precision within a predetermined range.

Therefore, it has been proposed to divide one sector in the radial direction and write the servo pattern with a plurality of magnetic recording heads, thereby shortening the writing time. Furthermore, it is known to use a reference position signal indicating a reference position recorded on a magnetic disc to record a servo pattern, as disclosed for instance in JP-A-11-260008. Furthermore, it is known to correct the setup of the magnetic recording heads by loading a correction disc as disclosed for instance in JP-A-2002-208242.

However, in the servo writer equipped with the magnetic recording heads, dispersion in magnetic density occurs on the magnetic face of a magnetic disc even when the exciting current to be applied to the exciting coils of the magnetic recording heads is constant. This problem is caused by the magnetic recording head, such as dimensional dispersion of constituent elements of the magnetic recording head, such as the gap interval of yokes, for example, dispersion of materials constituting the yokes, and the floating gap of the magnetic recording head from the magnetic disc.

FIG. 3 shows the relationship between the magnetic density and coercive force of the magnetic material. Servo patterns written with different magnetic flux densities (H₁, H₂, H₃) are different in coercive force (M₁, M₂, M₃). When the servo pattern is read by a magnetic reproducing head under such a state, the amplitude value is different among the different magnetic recording heads as shown in FIG. 4B or FIG. 4C with respect to the magnetic reproduction signal shown in FIG. 4A. If the magnetic reproduction signal has no sufficient S/N, it would be difficult to set the threshold value for binarization.

The present invention has been implemented in view of the problem described above. There is a need for a servo writer that can achieve a magnetic reproduction signal having uniform amplitude even when two or more magnetic recording heads are used. The present invention addresses this need.

### SUMMARY OF THE INVENTION

The present invention relates to a servo writing method and a servo writer, and a program for controlling the servo writer stored in a computer-readable storage medium. In particular, on a magnetic disc, a servo pattern used to detect the position of a magnetic head, an ID pattern for identifying the magnetic disc, a program, etc., are written.

One aspect of the present invention is a method of writing a servo pattern on a magnetic disc with a servo writer having an exciting current controller. The method includes reading, detecting, normalizing, and applying steps. The reading step involves reading a magnetic reproduction signal based on a magnetic pattern recorded on the magnetic disc. The detecting step involves detecting and holding peak values of an amplitude of the magnetic reproduction signal. The normalizing step involves normalizing the amplitude of the magnetic reproduction signal by calculating an average value of the magnetic reproduction signals corresponding to the magnetic recording heads based on the obtained peak values and dividing the amplitude value of each magnetic reproduction signal by the average. The applying step involves applying a correction value, which is the inverse of the normalized amplitude value, to the exciting current controller when the servo pattern is written on the magnetic disc so that the exciting current controller uniformly applies the exciting current to each of the magnetic recording heads.

The detecting step can detect the peak values of the amplitude values of a plurality of magnetic reproduction signals, and can calculate and hold the average value thereof. The detecting step can detect the positive peak values and the negative peak values of the magnetic reproduction signals, and the normalizing step can add the positive and negative peak values to normalize the magnetic reproduction signals.

Another aspect of the present invention is a servo writer for writing a servo pattern on a magnetic disc using a plurality of magnetic recording heads. The servo writer includes a magnetic reproducing head, a peak detector, an exciting current controller, and a CPU. The magnetic reproducing head can read a magnetic reproduction signal based on a magnetic pattern recorded on the magnetic disc. The peak detector can detect and hold peak values of an amplitude value of the magnetic reproduction signal read by the magnetic reproducing head. The exciting current controller can applying exciting current to each of the magnetic recording heads to record the magnetic pattern on the magnetic disc. The CPU can control the exciting current controller to enable the exciting current controller to uniformly apply exciting currents to the plurality of magnetic recording heads when recording the magnetic pattern on the magnetic disc, by calculating the average value of the magnetic reproduction signals corresponding to the respective magnetic recording heads from the peak values obtained by the peak detector, dividing the amplitude value of each of the magnetic reproduction signals by the average value to normalize the amplitude value, and applying the correction value to the exciting current controller.

The peak detector can detect the peak values of the amplitude values of the plurality of magnetic reproduction signals, and can calculate and hold the average value thereof. The peak detector can detect and hold the positive peak values and the negative peak values of the magnetic reproduction signals, and the CPU can add the positive and negative peak values for normalization. The CPU can store the correction value.

Another aspect of the present invention is a computer-readable storage medium that stores a program for writing a servo pattern with a servo writer on a magnetic disc thereof using a plurality of magnetic recording heads thereof. The program contains instructions or codes for reading a magnetic reproduction signal based on a magnetic pattern recorded on the magnetic disc by a magnetic reproducing head of the servo writer, detecting and holding peak values of an amplitude value of the magnetic reproduction signal from a peak detector of the servo writer, normalizing the amplitude value of the magnetic reproduction signal by calculating an average value of the magnetic reproduction signals corresponding to the magnetic recording heads from the obtained peak values and dividing the amplitude value of each magnetic reproduction signal by the average, and applying a correction value, which is the inverse of the normalized amplitude value, to an exciting current controller of the servo writer when the servo pattern is written on the magnetic disc so that the exciting currents are uniformly applied to the plurality of magnetic recording heads.

The detecting instruction can instruct to detect the peak values of the amplitude values of the plurality of magnetic reproduction signals, and can calculate and hold the average value thereof. The detecting instruction can instruct to detect the positive peak values and the negative peak values of the magnetic reproduction signals, and the normalizing instruction can instruct to add the positive and negative peak values for normalization.

### BRIEF DESCRIPTION OF THE DRAWINGS

FIG. 1 illustrates a conventional servo writer.

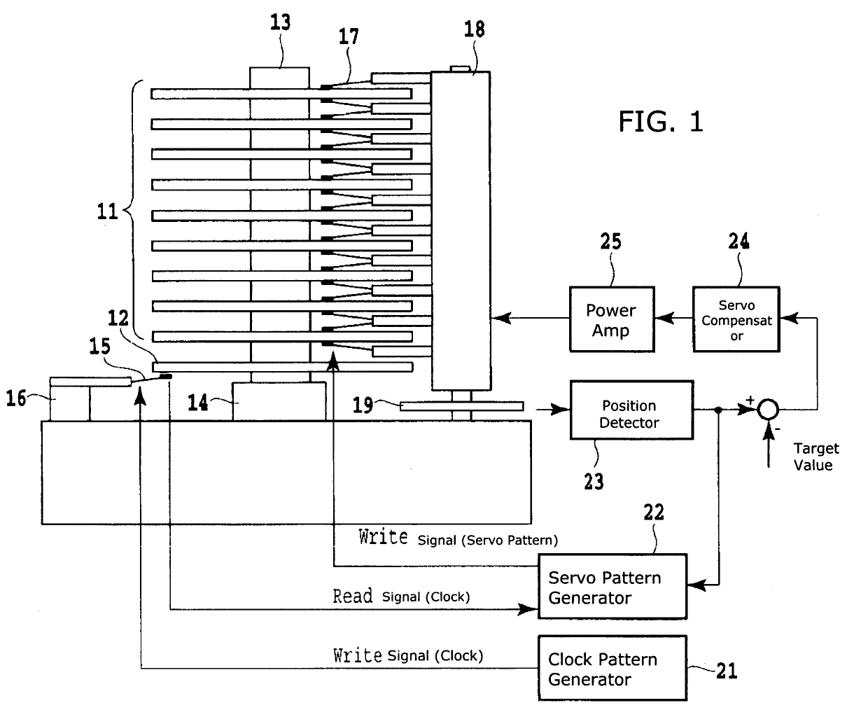

FIGS. 2A and 2B are plan views illustrating a clock head and a magnetic recording head of a conventional servo writer.

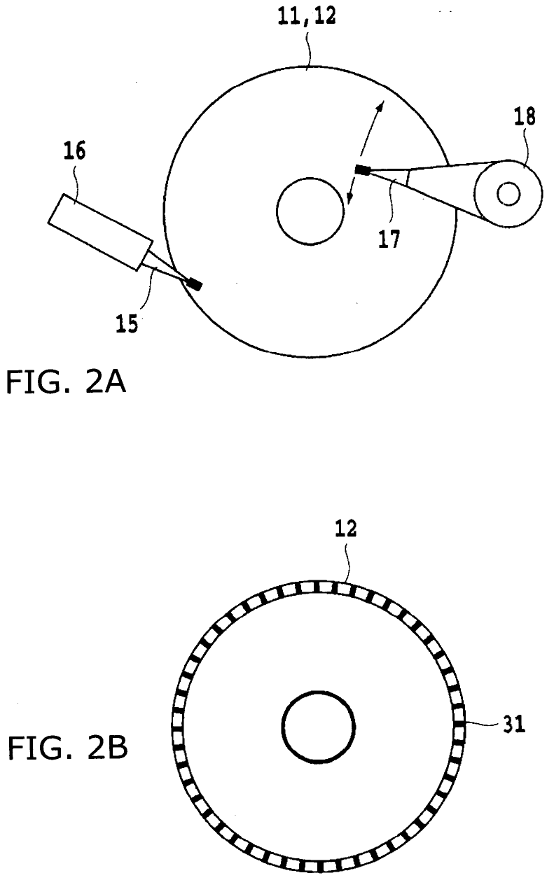

FIG. 3 is a diagram showing the relationship between magnetic density and coercive force of the magnetic material.

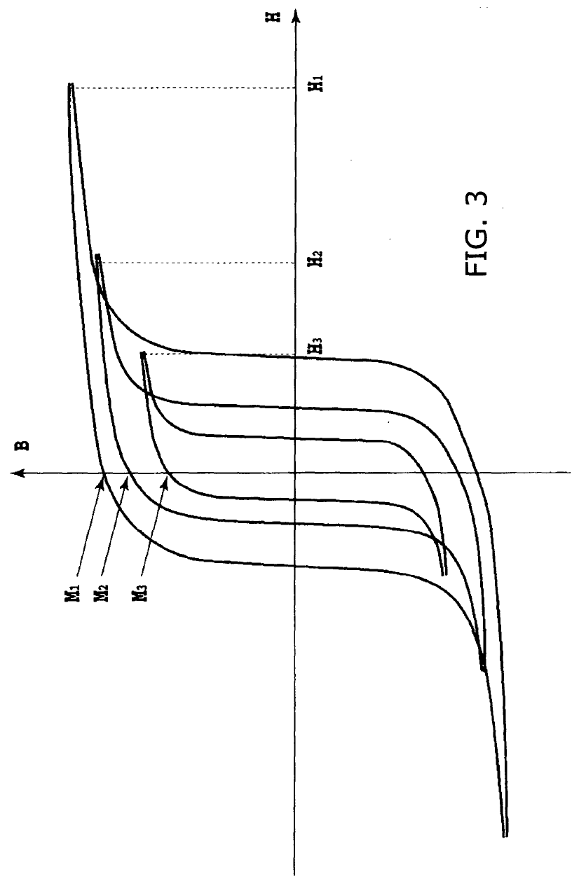

FIGS. 4A, 4B, and 4C are diagrams illustrating the amplitude value of a magnetic reproduction signal.

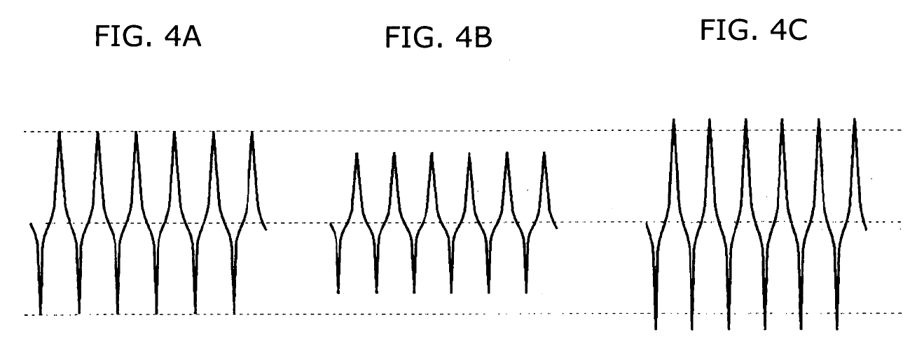

FIG. 5 schematically illustrates an embodiment of a servo writer according to the present invention.

FIG. 6 is a plan view showing a magnetic reproducing head and a magnetic recording head of the servo writer according to the present invention.

FIG. 7 is a flowchart showing the logistics of the servo writer according to the present invention.

FIG. 8 schematically illustrates the circuit construction of an embodiment of an exciting current controller according to the present invention.

FIG. 9 schematically illustrates the circuit construction of an embodiment of a peak detector according to the present invention.

FIG. 10 schematically illustrates the circuit construction of a second embodiment of a peak detector according to the present invention.

FIG. 11 schematically illustrates the circuit construction of a third embodiment of a peak detector according to the present invention.

FIG. 12 schematically illustrates the circuit construction of a fourth embodiment of a peak detector according to the present invention.

### DETAILED DESCRIPTION

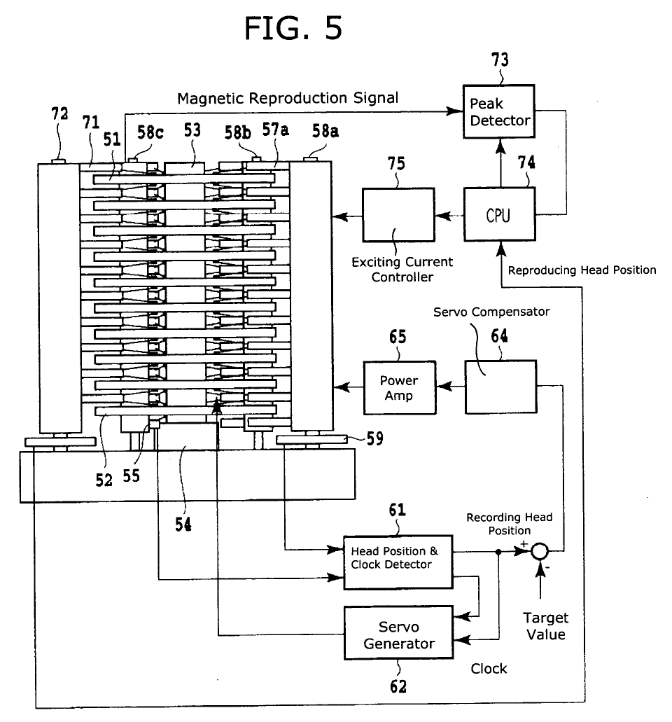

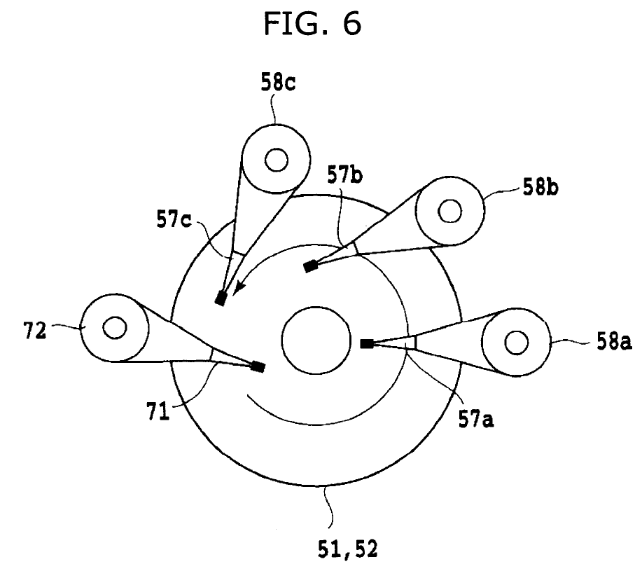

Referring to FIGS. 5 and 6, a servo writer includes a disc stack unit 53 having a number of magnetic discs 51 for recording servo signals thereon and a clock pattern disc 52, and a spindle motor 54 for rotating the disc stack unit 53 at several thousands rpm. The servo writer also includes a clock head 55 for reading a clock pattern from the clock pattern disc 52, a plurality of stacked magnetic recording heads 57a-57c for writing a servo pattern on the magnetic discs 51, and three sets of rotary positioners 58a-58c for positioning the stacked magnetic recording heads 57a-57c. At least one sector of at least one of the magnetic discs 51 is divided along the radial direction. A servo pattern is written to that sector with the magnetic recording heads 57a-57c to shorten the writing time.

Furthermore, the servo writer includes a rotary encoder 59 for detecting the position of the rotary positioners 58a-58c, a head position/clock detector 61 connected to the clock head 55 for reading the clock pattern, a servo pattern generator 62 for generating a servo pattern, a servo compensator 64 for calculating a servo compensation value to compensate any error between the detected position and the target position, and a power amplifier 65 for outputting the driving current for the rotary positioners 58a-58c based on the servo compensation value.

According to this embodiment, the servo writer is further equipped with magnetic reproducing heads 71 for reading the servo patterns written on the magnetic discs 51, a rotary positioner 72 for positioning the stacked magnetic reproducing heads 71, a peak detector 73 for detecting the peaks of the amplitude value of a magnetic reproduction signal, a CPU 74, and exciting current controllers 75 that calculate the exciting currents to be applied to the magnetic recording heads based on the peak values and apply the exciting currents to them. It should be noted that the number of the exciting current controllers 75 corresponds to the number of the magnetic recording heads 57a-57c stacked in the three sets of rotary positioners 58a-58c.

According to the construction described above, the position of each of the rotary positioners 58a-58c is detected by the head position/clock detector 61, and the error from the target position is fed back through the servo compensator 64 and the power amplifier 65 to make each of the magnetic recording heads 57a-57c follow the target position. Under the followed state, each of the magnetic recording heads 57a-57c writes the servo pattern generated in the servo pattern generator 62 on the magnetic disc 51 in synchronism with the clocks read from the clock pattern disc 52.

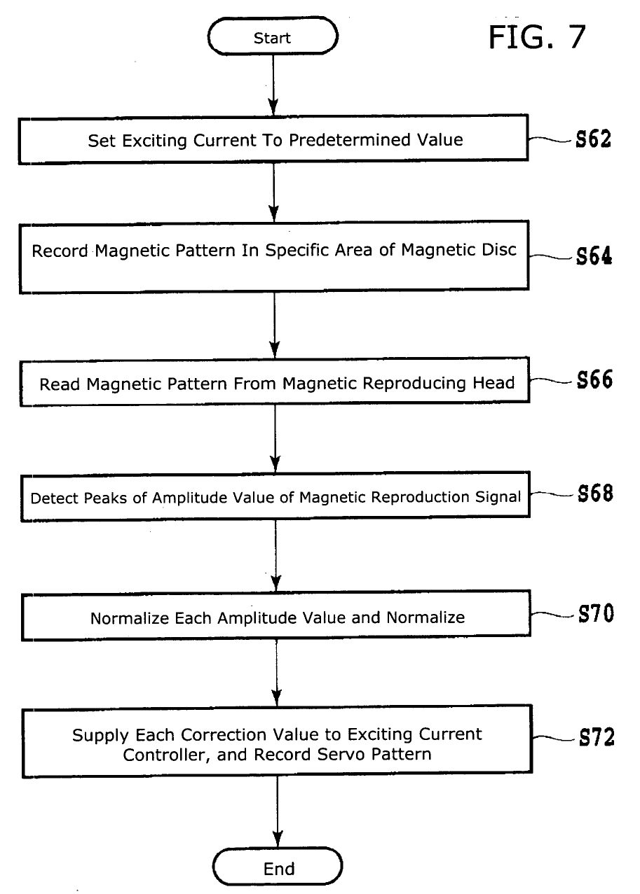

FIG. 7 shows an example of a servo writer logistic according to the present invention. Here, dispersion of the writing characteristic of the magnetic recording head is compensated before the servo pattern is written. First, the CPU 74 controls the exciting current controllers 75 so that all the amplitude values of the exciting currents to be applied to the magnetic recording heads 57a-57c are fixed to a predetermined value (step S62). Each of the magnetic recording heads 57a-57c is associated with a track to be written and records a magnetic pattern on the magnetic disc 51 in synchronism with the clocks read from the clock pattern disc 52 (step S64). Since the tracks on which the writing has been carried out by using the magnetic recording head 57 is known, the magnetic reproducing head 71 can be positioned. Under this state, the position control of the magnetic reproducing head 71 is switched based on the magnetic pattern, and a magnetic reproduction signal is read from each magnetic disc 51 (step S66). At this time, the peak detector 73 detects and holds one peak or both (positive and negative waveforms) the peaks of the amplitude value of each magnetic reproduction signal (step S68). The CPU 74 reads the peak values held in the peak detector 73, calculates the average value of the magnetic reproduction signals corresponding to the respective magnetic recording heads 57a-57c, and divides the amplitude value of each magnetic reproduction signal by the average value to normalize the amplitude value. The CPU 74 then stores the inverse of the amplitude value thus normalized as a correction value (step S70). When the servo pattern is recorded on the magnetic disc 51, the CPU 74 supplies the correction value to the exciting current controller 75, and applies the exciting current of the amplitude value thus compensated to each of the magnetic recording heads 57a-57c (step S72). The magnetic pattern written to compensate the dispersion of the writing characteristic can be deleted by controlling the exciting current controllers 75 so that all the amplitude values of the exciting currents applied to the magnetic recording heads 57a-57c are equal to the predetermined value, and making the exciting currents flow in the opposite direction.

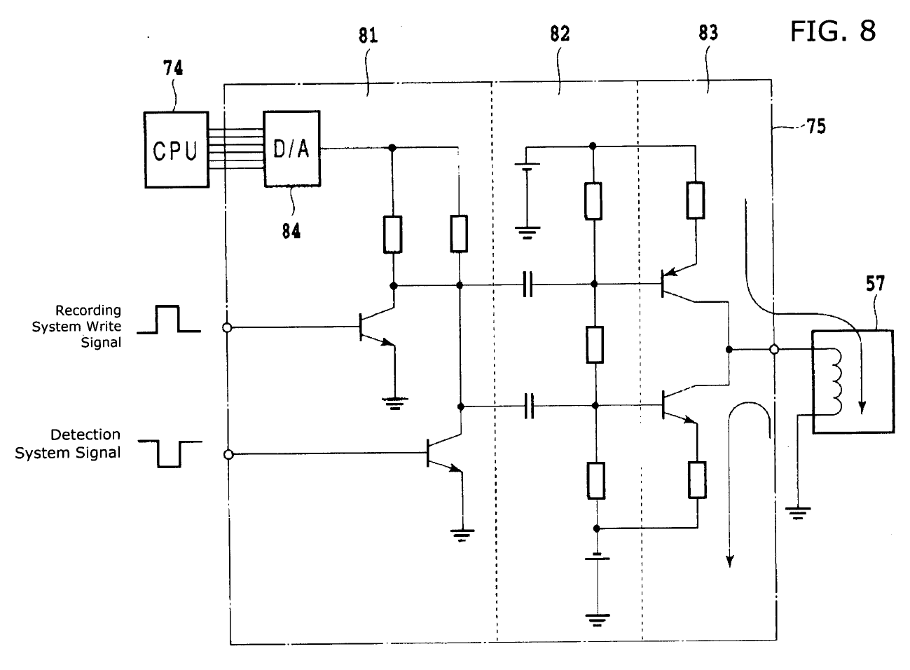

FIG. 8 schematically illustrates an embodiment of the exciting current controller according to the present invention. The exciting current controller 75 includes a pulse amplitude conversion circuit 81 for determining the amplitude value of the exciting current, an alternating couple/bias circuit 82, and a constant current circuit 83 for outputting the exciting current corresponding to the amplitude value thus determined. The pulse amplitude conversion circuit 81 inputs the servo pattern generated in the servo pattern generator 62 as a recording system Write signal. Furthermore, the digital signal from the CPU 74 is converted to an analog signal by a D/A converter 84, and then applied to the recording system Write signal. As described above, the exciting current of the amplitude value for which the dispersion of the writing characteristic is compensated is output to the respective magnetic recording head 57a-57c via the alternating couple/bias circuit 82 and the constant current circuit 83.

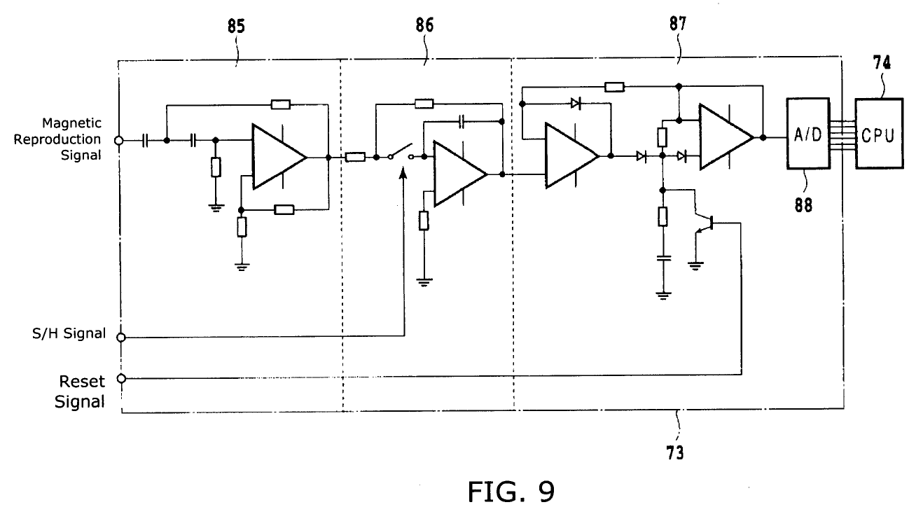

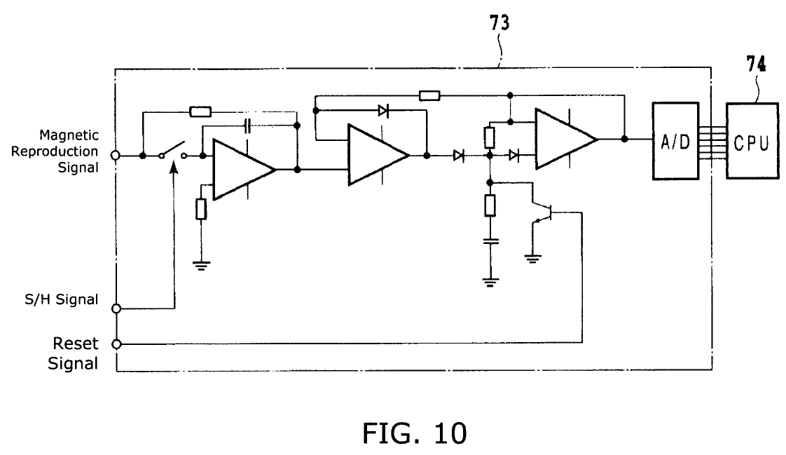

FIG. 9 illustrates a first embodiment of a peak detector according to the present invention. The peak detector 73 is equipped with a high pass filter (HPF) circuit 85, a sampling/hold (S/H) circuit 86 for sampling the magnetic reproduction signal on the basis of an S/H signal, and a peak value detecting circuit 87 for holding the peak value of the amplitude value thus sampled, converting it to a digital signal by an A/D converter 88 and then outputting the digital signal to the CPU 74. The peak detector can be designed so that the high pass filter (HPF) circuit 85 is omitted, as in the case of the second embodiment shown in FIG. 10.

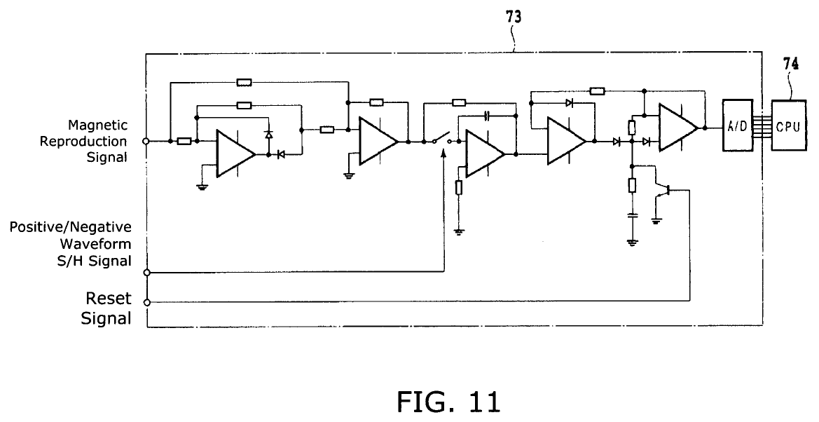

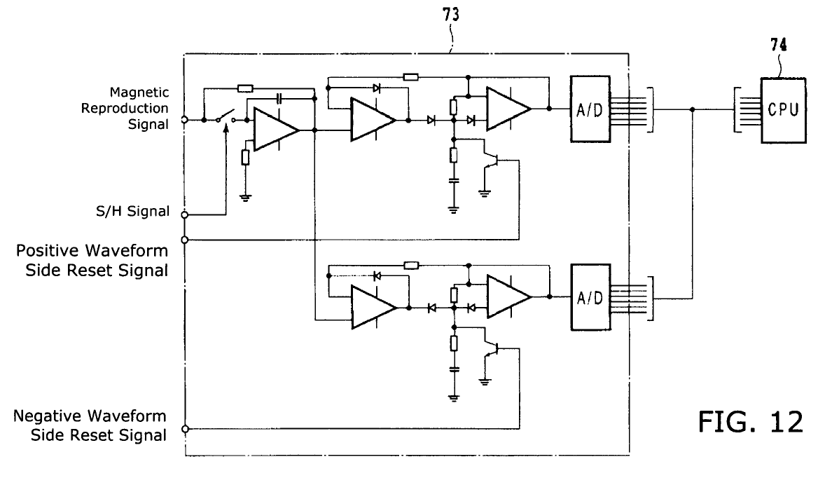

FIG. 11 illustrates a third embodiment of a peak detector according to the present invention. Normally, the magnetic reproduction signal is symmetrical between positive and negative sides, so that it is sufficient to detect only the peak value at the positive waveform side by the peak detector shown in FIGS. 9 and 10. However, according to the third embodiment, the peak values of both the positive and negative waveforms are detected to enhance the detection precision. Furthermore, in the fourth embodiment illustrated in FIG. 12, the peak values of both the positive and negative waveforms are separately detected.

According to the present invention, before the servo pattern is written, the dispersion of the writing characteristic in the magnetic recording head is compensated so that magnetic reproduction signals having uniform amplitude can be achieved even when a plurality of magnetic recording heads are used.

As described above, according to the present invention, the CPU of the servo writer records a magnetic pattern so that all the exciting currents applied to plural magnetic recording heads are made constant or uniform, the correction value corresponding to each magnetic recording head is calculated and stored on the basis of the peak value of the magnetic reproduction signal read by one magnetic reproducing head, and the correction value is supplied to the exciting current controller when the servo pattern is written on the magnetic disc, so that the magnetic reproduction signal having a uniform amplitude can be achieved even when a plurality of magnetic recording heads are used.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosure of the priority application, JP 2003-028745, in its entirety, including the drawings, claims, and the specification thereof, is incorporated herein by reference.

What is claimed is:

1. A method of writing a servo pattern on a magnetic disc with a servo writer having an exciting current controller, comprising the steps of:
reading a magnetic reproduction signal based on a magnetic pattern recorded on the magnetic disc;
detecting and holding peak values of an amplitude of the magnetic reproduction signal;
normalizing the amplitude of the magnetic reproduction signal by calculating an average value of the magnetic reproduction signals corresponding to the magnetic recording heads based on the obtained peak values and dividing the amplitude value of each magnetic reproduction signal by the average; and
applying a correction value, which is the inverse of the normalized amplitude value, to the exciting current controller when the servo pattern is written on the magnetic disc so that the exciting current controller uniformly controls the exciting current applied to each of the magnetic recording heads.

2. The method according to claim 1, wherein the detecting step detects and holds the peak values of the amplitude values of a plurality of magnetic reproduction signals, and the normalizing step calculates and holds the average value thereof.

3. The method according to claim 1, wherein the detecting step detects positive peak values and negative peak values of the magnetic reproduction signals, and the normalizing step adds the positive and negative peak values to normalize the magnetic reproduction signals.

4. The method according to claim 2, wherein the detecting step detects positive peak values and negative peak values of the magnetic reproduction signals, and the normalizing step adds the positive and negative peak values to normalize the magnetic reproduction signals.

5. A servo writer for writing a servo pattern on a magnetic disc using a plurality of magnetic recording heads, comprising:
a magnetic reproducing head for reading a magnetic reproduction signal based on a magnetic pattern recorded on the magnetic disc;
a peak detector for detecting and holding peak values of an amplitude value of the magnetic reproduction signal read by the magnetic reproducing head;
an exciting current controller for applying exciting current to each of the magnetic recording heads to record the magnetic pattern on the magnetic disc; and
a CPU for controlling the exciting current controller to uniformly apply the exciting currents to the plurality of magnetic recording heads when recording the magnetic pattern on the magnetic disc by calculating the average value of the magnetic reproduction signals corresponding to the respective magnetic recording heads from the peak values obtained by the peak detector, dividing the amplitude value of each of the magnetic reproduction signals by the average value to normalize the amplitude value, and applying the correction value to the exciting current controller.

6. The servo writer according to claim 5, wherein the peak detector detects the peak values of the amplitude values of the plurality of magnetic reproduction signals, and calculates and holds the average value thereof.

7. The servo writer according to claim 5, wherein the peak detector detects and holds the positive peak values and negative peak values of the magnetic reproduction signals, and the CPU adds the positive and negative peak values for normalization.

8. The servo writer according to claim 6, wherein the peak detector detects and holds the positive peak values and negative peak values of the magnetic reproduction signals, and the CPU adds the positive and negative peak values for normalization.

9. A computer-readable storage medium storing a program for writing a servo pattern with a servo writer on a magnetic disc thereof using a plurality of magnetic recording heads thereof, the program containing instructions for:
reading a magnetic reproduction signal based on a magnetic pattern recorded on the magnetic disc by a magnetic reproducing head of the servo writer;
detecting and holding peak values of an amplitude value of the magnetic reproduction signal from a peak detector of the servo writer;
normalizing the amplitude value of the magnetic reproduction signal by calculating an average value of the magnetic reproduction signals corresponding to the magnetic recording heads from the obtained peak values and dividing the amplitude value of each magnetic reproduction signal by the average; and
applying a correction value, which is the inverse of the normalized amplitude value, to an exciting current controller of the servo writer when the servo pattern is written on the magnetic disc so that the exciting current controller uniformly applies the exciting current to the plurality of magnetic recording heads when recording the magnetic pattern.

10. The medium according to claim 9, wherein the detecting instruction detects the peak values of the amplitude values of the plurality of magnetic reproduction signals, and calculates and holds the average value thereof.

11. The medium according to claim 9, wherein the detecting instruction detects positive peak values and negative peak values of the magnetic reproduction signals, and the normalizing instruction adds the positive and negative peak values for normalization.

12. The medium according to claim 10, wherein the detecting instruction detects positive peak values and negative peak values of the magnetic reproduction signals, and the normalizing instruction adds the positive and negative peak values for normalization.
